(19) United States
(12) Patent Application Publication
(10) Pub. No.: US 2026/0288835 A1
(43) Pub. Date: Sep. 24, 2026

(54) CLUSTER AWARE CACHING FOR VECTOR DATABASE

(71) Applicant: Amazon Technologies, Inc., Seattle, WA (US)

(72) Inventors: Marc Brooker, Seattle, WA (US); Mrithyunjaya Kumar Annapragada, Concord, MA (US)

(73) Assignee: Amazon Technologies, Inc., Seattle, WA (US)

(21) Appl. No.: 19/085,883

(22) Filed: Mar. 20, 2025

(51) Int. Cl. G06F 16/334; G06F 16/31; G06F 16/3329

(52) U.S. Cl. CPC G06F 16/3347; G06F 16/322

(57) ABSTRACT

A vector-labeled database may improve a cache hit rate for read requests by performing a partial approximate nearest neighbor index search at a router to designate the cache that results of a read request are to be written to. The selected cache may be associated with a particular node of a layer of an approximate nearest neighbor index search. The router may direct all reads with search vectors close to the particular node to the associated cache.

### BACKGROUND

Vector databases may be inefficient at large scale due to the dimensionality of vectors. High dimensionality may provide a strong correlation between nearby vectors, but may also create difficulties in organizing the database, and may negatively impact cache hit rates. Multi-dimensional vectors which are nearby in some dimensions may be distant from each other in other dimensions, which may complicate organization and distribution of vector databases.

### BRIEF DESCRIPTION OF THE DRAWINGS

FIG. 1 is a block diagram of a vector-labeled database including a hot tier optimized for writes and a cold tier optimized for reads, according to some embodiments.

FIG. 2 is a block diagram of a write request generator and a read request generator with an encoder which is capable of generating multi-dimensional vectors, according to some embodiments.

FIG. 3 is a block diagram illustrating a search result merger, according to some embodiments.

FIG. 4 is a two-dimensional representation of a hierarchical navigable small world graph, which may be usable as an index to search a cold tier of a vector-labeled database, according to some embodiments.

FIG. 5A is a two-dimensional representation of a set of vectors undergoing vector quantization, according to some embodiments.

FIG. 5B is a block diagram illustrating a vector undergoing product quantization, according to some embodiments.

FIG. 6 is a flowchart of a process for writing new data items and associated new vectors into a vector-labeled database which includes a hot tier, a medium tier, and a cold tier, according to some embodiments.

FIG. 7 is a flowchart of a process for reading data items from a vector-labeled database which includes a hot tier, a medium tier, and a cold tier, according to some embodiments.

FIG. 8A is a flowchart of a process for merging search results comprising multiple versions of a data item, according to some embodiments.

FIG. 8B is a flowchart of a process for merging search results based on the distances between the search vector and the vectors selected in an approximate nearest neighbor search of the tiers, according to some embodiments.

FIG. 8C is a flowchart for a process of merging search results based on a similarity between the read request and data items associated with vectors selected in an approximate nearest neighbor search of the tiers, according to some embodiments.

FIG. 8D is a flowchart for a process of returning data in response to a read request which includes a return order, according to some embodiments.

FIG. 9 is a block diagram of elements involved in a read process for a vector-labeled database which includes a cluster-aware router, according to some embodiments.

FIG. 10A is an illustration of actions taken by elements involved in a read process for a vector-labeled database when data responsive to a read is not identified in a cache, according to some embodiments.

FIG. 10B is an illustration of actions taken by elements involved in a read process for a vector-labeled database when data responsive to a read is identified in a cache, according to some embodiments.

FIG. 11 is a flowchart of a process for responding to a read request for a vector-labeled database which uses a cluster-aware router, according to some embodiments.

FIG. 12A is a flowchart of a process for updating an approximate nearest neighbor index search in response to a batch write, according to some embodiments.

FIG. 12B is a flowchart of a process for updating an approximate nearest neighbor index search in response to a newly allocated cache for the vector-labeled database, according to some embodiments.

FIG. 13 is a block diagram illustrating an example computer system that implements some, or all, of the techniques described herein, according to some embodiments.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as described by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the scope of the present invention. The first contact and the second contact are both contacts, but they are not the same contact.

### DETAILED DESCRIPTION

A vector-labeled database may include multi-dimensional vectors respectively associated with data items. The vector-labeled database may include one or more hot tiers optimized for writes, one or more medium tiers optimized to balance reads and writes, and one or more cold tiers optimized for reads, which may improve the speed at which transactions to the database may appear in response to read requests. The vector-labeled database may also use a cluster-aware router to cache data items identified during read requests, which may increase a likelihood that subsequent reads hit data in the cache.

Various architectures may be suitable for each of the hot, medium, and cold tiers. A cold tier may store the most vectors, and may use an organized architecture which is relatively fast to read to and relatively slow to write to, due to the high amount of organization. A hot tier may store the fewest vectors, and may use a relatively less organized architecture which is relatively fast to write to and relatively slow to read to, due to the lower amount of organization. An example of an architecture suitable for a cold tier may be an architecture that is searchable using an approximate nearest neighbor index, such as a hierarchical navigable small world graph. An example of an architecture suitable for a hot tier may be an architecture that does not use an index, for example, a transaction log.

In some embodiments, the vector-labeled database may use an architecture which balances the speed of reads and the speed of writes for a medium tier. The hot tier may batch vectors associated with data items which have been least recently updated to the medium tier, and the medium tier may accept some write requests. In some embodiments, the vector-labeled database may use two, or more, hot tiers with the same or similar architecture, and alternatively select a hot tier to receive write requests and to batch the transactions to the cold tier. The vector-labeled database may alternate the hot tiers based on a determination that a threshold amount of transactions have occurred at the hot tier receiving write requests.

Vectors included in a vector-labeled database may be generated based on the respective associated data items, such that a particular multi-dimensional vector may describe the data item the vector represents. A vector-labeled database may use a trained machine learning model known in the art as an encoder to generate vectors based on data items. The vector-labeled database may store the associated data item directly or may store a pointer to the associated data item. In some embodiments, the vector-labeled database may generate a data item based on the associated vector using a trained machine learning model known in the art as a decoder.

The vector-labeled database may accept read requests which include a search vector or a data item which an encoder may use to generate a search vector, for example, the data item may be a user input describing the search a user is performing on the database in a natural language. The vector-labeled database may use an encoder to generate a search vector based on the natural language description and perform an approximate nearest neighbor search using the generated search vector.

In some embodiments, the vector-labeled database may accept read requests specifying a region of vector space, for example, using a range for each dimension of the vector space. The vector-labeled database may generate a search vector using the midpoint of each range, and may return data items associated with the vectors in the region of vector space.

A storage tier which is write-optimized relative to another tier may be able to perform relatively faster transactions compared to the other tier and may have relatively less structure compared to the other tier. For example, a list of changes which are made to a dataset may be relatively more write-optimized than the dataset. A storage tier which is read-optimized compared to another tier may be able to perform relatively faster reads compared to the other tier and may have relatively more structure compared to the other tier. For example, a categorized dataset may be more read-optimized than the same dataset in an uncategorized format. As another example, a hierarchical file structured storage or a tree based storage structure may each have more structure than a flat file storage structure, and thus may be relatively more read-optimized than the flat file storage structure.

One or more of the embodiments described herein may be capable of achieving one or more of the following technical effects. Embodiments may reduce the amount of time between a write request being made to a vector-labeled database and the data associated with the write request being retrievable via a read request to the vector-labeled database. Embodiments may reduce the latency of a vector-labeled database as a result of transactions to a read-optimized cold tier occurring in batches. Embodiments may reduce the latency of a vector-labeled database by increasing the vector-labeled database's cache hit rate. Embodiments may enable efficient distribution of a vector-labeled database by effective addition of cache instances.

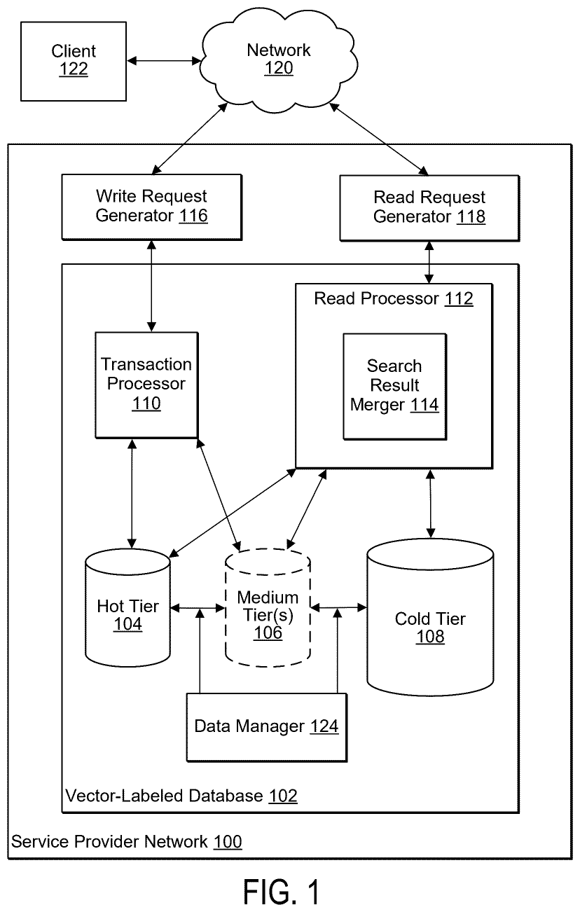

FIG. 1 is a block diagram of a vector-labeled database including a hot tier optimized for writes and a cold tier optimized for reads, according to some embodiments.

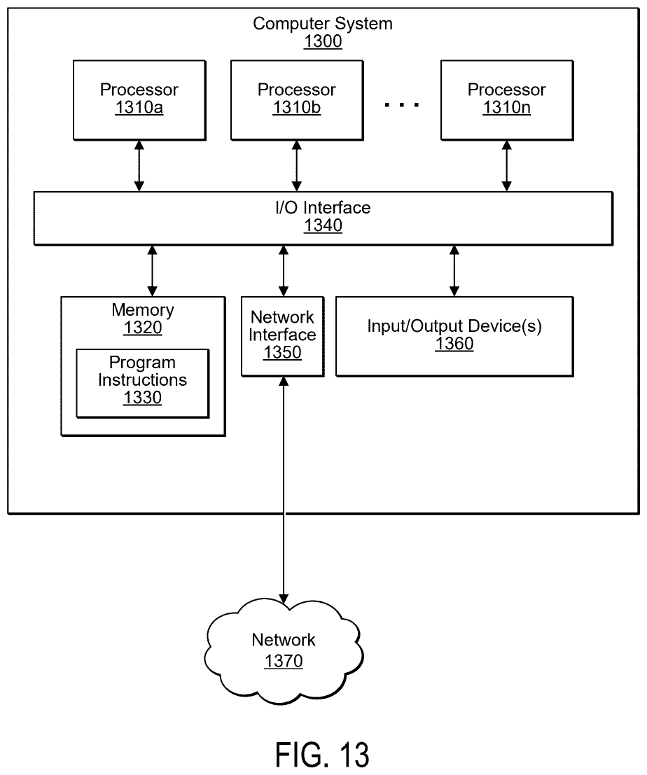

A service provider network 100 may host a vector-labeled database 102 and other services using computing devices such as computer system 1300 illustrated in FIG. 13. Clients 122 may use a network 120 to interact with the vector-labeled database. In some embodiments, clients 122 may be internal to a service provider network 100. Clients 122 may send write requests, requests for write requests, read requests, and requests for read requests to a vector-labeled database 102. A write request generator 116 may generate write requests, particularly by generating a vector to be associated with a data item specified in a request for a write request. A read request generator 118 may generate read requests, particularly by generating a search vector based on user input or a data item.

The vector-labeled database 102 may include a hot tier 104, a medium tier 106, and a cold tier 108. The hot tier 104 may be relatively more write-optimized than the medium tier 106 and cold tier 108. The cold tier 108 may be relatively more read-optimized than the medium tier 106 and hot tier 104. In some embodiments, the medium tier 106 may share the same architecture as the hot tier 104, and the medium tier 106 may have stopped receiving write requests and started a process of batching vectors included in previous write requests to be written to the cold tier 108. In some embodiments, a vector-label database 102 may include multiple medium tiers 106 based on the size and workload of the vector-label database 102. For example, a vector-labeled database 102 which contains a large amount of frequently updated data may include more medium tiers 106 with varying degrees of write optimization than a smaller vector-labeled database 102 with fewer instances of frequently updated data.

A data manager 124 may cause batching operations to occur between the tiers. In some embodiments, the data manager 124 may determine some data items stored in the hot tier 104 have most recently been updated beyond a threshold amount of time, and batch the vectors associated with the data items to the medium tier 106, or the cold tier 108 in an embodiment which does not include a medium tier 106.

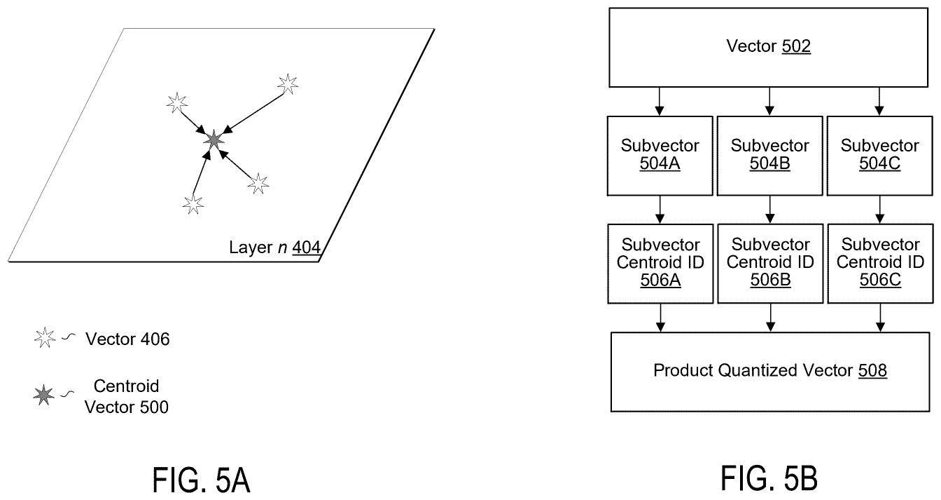

The vector-labeled database 102 may use multi-dimensional vectors to store and retrieve data items. The multi-dimensional vectors may have more dimensions than a vector that is usable for real-world physical calculations, i.e., the multi-dimensional vectors may be n-dimensional vectors where nis larger than 3. The multi-dimensional vectors may be vector quantized or product quantized, as is described in additional detail with regard to FIGS. 5A-5B.

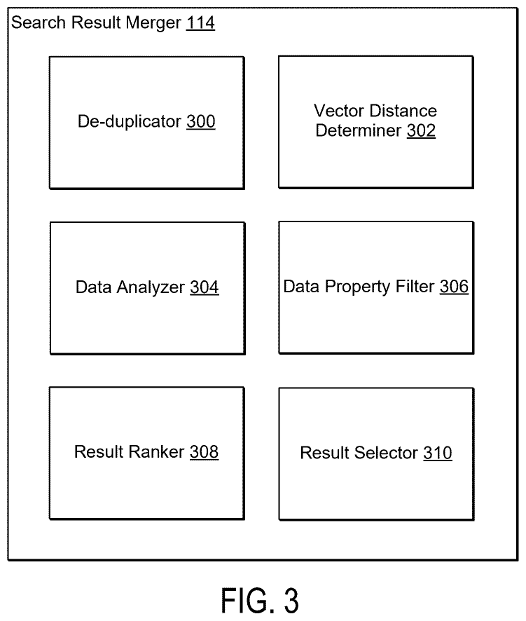

A transaction processor 110 may send writes to be written to the hot tier 104 and, when appropriate, the medium tier 106. A read processor 112 may perform an approximate nearest neighbor search using a search vector on the hot tier 104, the medium tier 106, and the cold tier 108. Data items may appear in a read as soon as the associated vectors are written to any of the vector-labeled database's tiers. The read processor 112 may select a portion of the results of the approximate nearest neighbor searches as a combined result using a search result merger 114, described in more detail in relation to FIG. 3.

A data manager 124 may move vectors associated with data items which are being updated from a colder tier to a warmer tier, for example from the cold tier 108 to a hot tier 104. The data manager 124 may also batch newly written vectors from a warmer tier to a colder tier, for example, from the hot tier 104 to the cold tier.

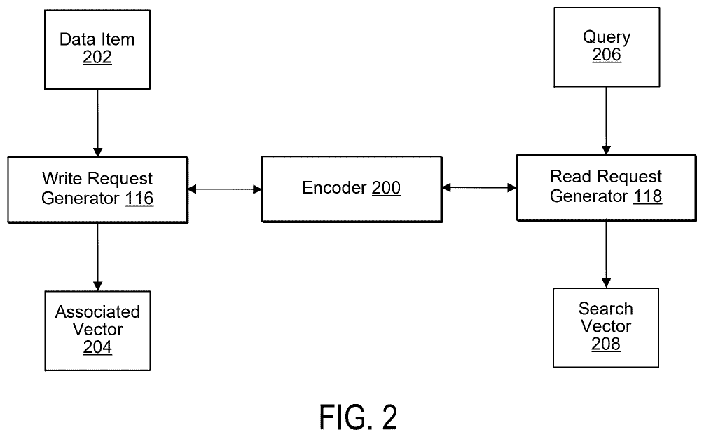

FIG. 2 is a block diagram of a write request generator and a read request generator with an encoder which is capable of generating multi-dimensional vectors, according to some embodiments.

A vector-labeled database may store and retrieve data items 202 using multi-dimensional vectors that are associated with the data items 202. The vector-labeled database may use a write request generator 116 to generate an associated vector 204 for a data item 202, for data items 202 that are received in a request for a write request, i.e., without an associated vector 204. Similarly, the vector-labeled database may use a search vector 208 to retrieve data items 202. For a query 206 that does not include a search vector 208, i.e., a request for a read request, the vector-labeled database may use a read request generator 118 to generate a search vector 208. The query 206 may include a data item or user input that the read request generator 118 may use to generate a search vector 208. A data item used as a query 206 may result in read responses comprising data items which are similar to the query data item. User input used as a query 206 may result in read responses comprising data items which are responsive to the user input, for example, data items which match a natural language description included in the user input or data items which respond to a question included in the user input.

The write request generator 116 and read request generator 118 may use an encoder 200 to generate the multi-dimensional vectors that are used for associated vectors 204 and search vectors 208. In some embodiments, the write request generator 116 and read request generator 118 may each be an encoder 200, or may be the same encoder 200. An encoder 200 may be a machine learning model that has been trained to generate a multi-dimensional vector based on an input, such as a data item 202. The vector-labeled database may use a single encoder 200 or copies of one encoder 200 to generate multi-dimensional vectors to maintain consistency of the relationships of data items included in the vector-labeled database.

FIG. 3 is a block diagram illustrating a search result merger, according to some embodiments.

A search result merger 114 may combine the results of the searches of the hot tier, medium tier, and cold tier. The approximate nearest neighbor searches may each result in multiple multi-dimensional vectors which are approximate nearest neighbor vectors of the search vector. The search result merger 114 may reduce the amount of multi-dimensional vectors, and associated data items, to return in response to the read request by merging the search results.

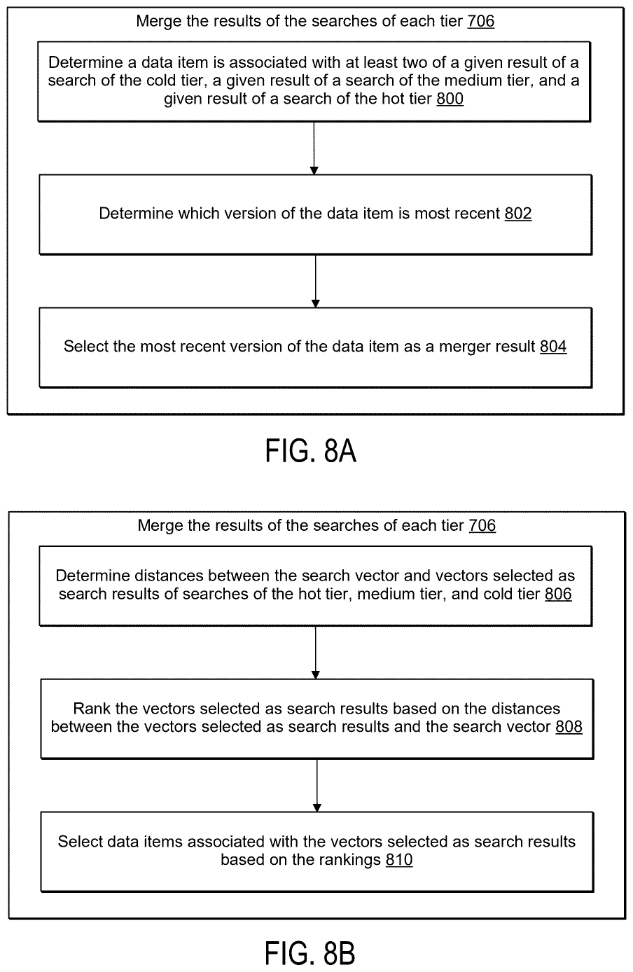

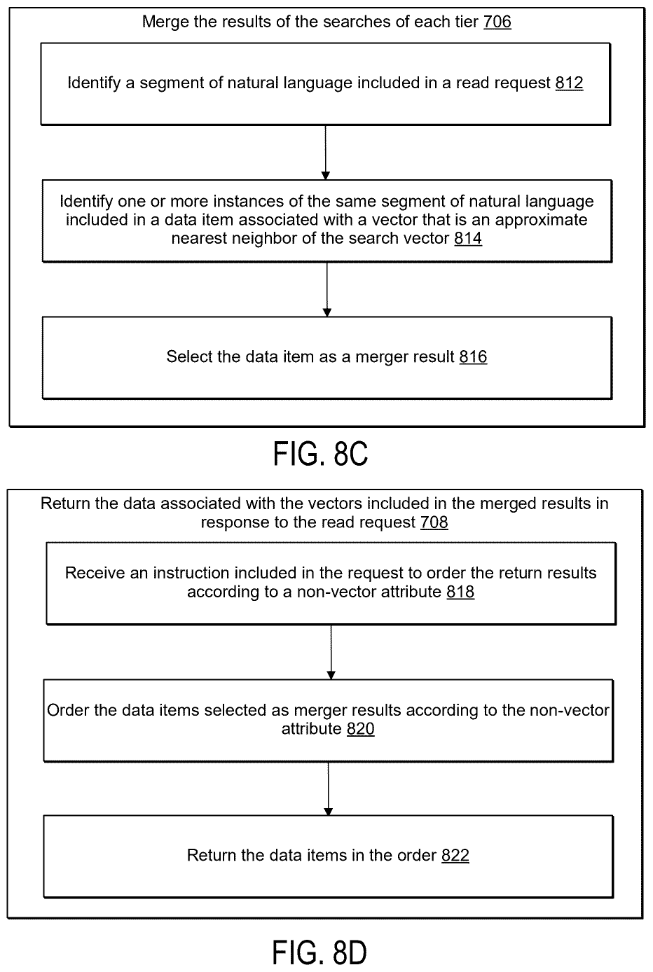

A search result merger 114 may use a de-duplicator 300 to identify that two or more data items associated with vectors from the database searches are different versions of each other. The de-duplicator 300 may locate timestamps associated with the different versions and select a version with the most recent timestamp. A timestamp may use actual time, or may use a logical sense of time such as a transaction order. A process for using a de-duplicator 300 is described in relation to FIG. 8A.

A search result merger 114 may use a vector distance determiner 302 to determine distances between the search vector and the vectors returned by the approximate nearest neighbor searches of the hot tier, medium tier, and the cold tier. The distances may be Euclidean distances, cosine similarity, or another kind of distance. The distances may be used by a result ranker 308 as part of determining relevance ranks for the vectors returned by the approximate nearest neighbor searches of the hot tier, medium tier, and the cold tier. A process for using a vector distance determiner 302 with a result ranker is described in relation to FIG. 8B.

A data analyzer 304 may analyze data items associated with the vectors returned by the approximate nearest neighbor searches of the hot tier, medium tier, and the cold tier. For example, the data analyzer 304 may determine a data item is associated with the read request and select the data item as a merger result. An example may be that the read request includes a natural language query for “James Smith's Theory of Quantum Mechanics” and a data item associated with a vector located by one of the approximate nearest neighbor searches is a book titled “Theory of Quantum Mechanics” by an author named James Smith. The data analyzer 304 may select this data item as a merger result to be returned in response to the read request. As another example, the data analyzer 304 may determine a data item is not a type of data item anticipated by a read request and exclude the data item from the merger results. An example may be that the read request includes a specification for video files, and a data item associated with a vector located by one of the approximate nearest neighbor searches is a text file. The data analyzer 304 may exclude the text file from the merger results. A process for using a data analyzer 304 is described in relation to FIG. 8C.

A data property filter 306 may exclude data items with incorrect properties from the merger results. As an example, a read request may specify that the desired search results are scientific articles. The data property filter 306 may exclude data items other than scientific articles. An alternative to a data property filter 306 may be to designate separate portions of a vector-labeled database by the properties of data items in the separate portions, and to perform an approximate nearest neighbor search on only the appropriate portion.

A result ranker 308 may use results of the de-duplicator 300, vector distance determiner 302, data analyzer 304, and data property filter 306 to determine rankings and orderings for data items associated with the vectors located by the approximate nearest neighbor searches. The result ranker 308 may base the rankings and orderings on the determined distances, the analysis, or other factors. For example, the result ranker 308 may, by default, rank and order data items according to vector properties, such as the distances provided by vector distance determiner 302. A data item associated with the highest ranked vector may be the first data item returned in response to the request. As another example, a request may include an instruction to order data items alphabetically, for example, and the result ranker 308 may use text identified by data analyzer 304 to order the data items alphabetically. The result selector 310 may select the data items to return based on the ranking determined by the result ranker, e.g., by distance, and return the data items in the order determined by the result ranker 308, e.g., alphabetically.

The result selector 310 may select the data items to be included in a merger result to be returned in response to the read request. There may be a limit on the amount of data items to be returned in response to read requests, for example, the result selector 310 may select up to a maximum number of data items, such as five data items. The result selector 310 may use the results of the data analyzer 304, the data property filter 306, and the result ranker 308 to order and select data items to be returned in response to the request.

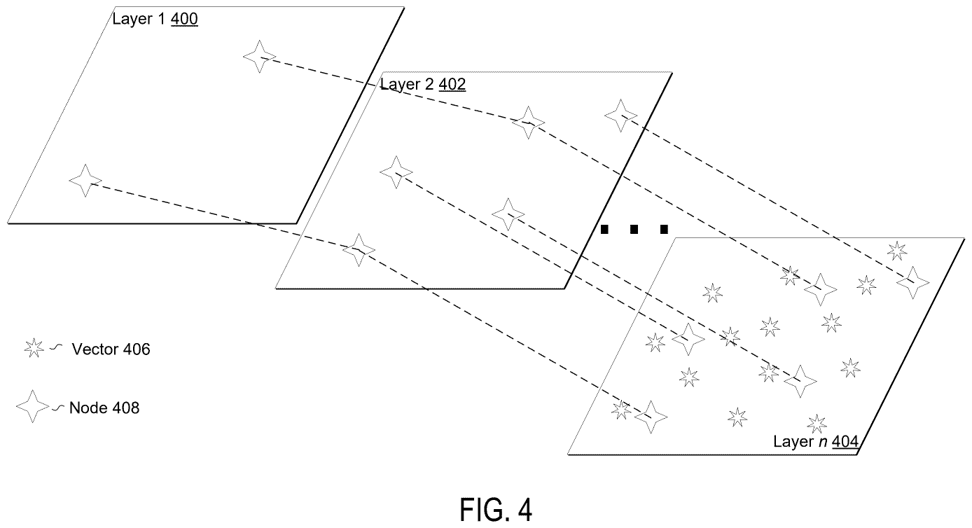

FIG. 4 is a two-dimensional representation of a hierarchical navigable small world graph, which may be usable as an index to search a cold tier of a vector-labeled database, according to some embodiments.

An example of an architecture which is read-optimized and suitable for a cold tier of a vector-labeled database is a hierarchical navigable small world graph. The graph has a set of layers (i.e., layer 1 400, layer 2 402, and layer n 404) which each include a set of nodes 408. The lowest layer, i.e., layer n 404, also includes vectors 406 of the vector-labeled database. A search of the database may travel through the upper layers via a node 408 which is the closest node 408 of the layer to a search vector. An approximate nearest neighbor search index such as a hierarchical navigable small world graph may reduce an amount of computational work needed to locate approximate nearest neighbor vectors during a read, and the high amount of organization may increase an amount of work needed during writes to rebalance the index.

An approximate nearest neighbor search index such as a hierarchical navigable small world graph may be used for additional organizational purposes for the vector-labeled database. For example, the vector-labeled database may be sharded based on a non-database layer of the index, such as layer 1 400 or layer 2 402, such that vectors associated with respective clusters that are based on the nodes of the index are stored together. As another example, a router for caches for the vector-labeled database may use a non-database layer of the index, such as layer 1 400 or layer 2 402, to reduce the amount of vectors which may be associated with any given one of a set of caches, which may improve a cache hit rate for the database.

An example process for inserting a vector 406 into a hierarchical navigable small world graph may be to determine a highest search layer the vector 406 is represented at as a node 408, search the layers above that layer for an entry point, and search the layer for nearest-neighbor nodes to establish routes with the new node. For example, an index manager may determine a new vector 406 is to be represented as a node 408 at layer 2 402. The index manager may find the closest, or approximate closest, node 408 at layer 1 400 as an entry point, and find approximate nearest neighbors of the new node 408 at layer 2 402 via a search through the entry point of layer 1 400. The index manager may establish routes from the new node 408 at layer 2 402 to the approximate nearest neighbor nodes 408 at layer 2 402. The index manger may continue establishing approximate nearest neighbor routes to the new node 408 through the layers. The index manager may also insert a new vector 406 at layer n 404 and may establish approximate nearest neighbor routes to other vectors 406 for later use in searches.

FIG. 5A is a two-dimensional representation of a set of vectors undergoing vector quantization, according to some embodiments.

Vector compression techniques, such as vector quantization and product quantization, may enable vector data to be stored using significantly less memory than would be used without vector compression with similar accuracy of approximate nearest neighbor search. Vector quantization may reduce the amount of memory needed to store information in a vector-labeled database at the cost of some accuracy. Vectors 406 may be represented by a centroid vector 500, and searches of the vector-labeled database may find the centroid vector and return the data items associated with the vectors 406 represented by the centroid vector 500. For a vector-labeled database which retrieves data using an approximate nearest neighbor search, the decrease in accuracy may be acceptable given the improvement in storage space.

FIG. 5B is a block diagram illustrating a vector undergoing product quantization, according to some embodiments.

Product quantization may also reduce the amount of memory needed to store information in a vector-labeled database at the cost of some accuracy. A vector 502 may be divided into subvectors 504 which each correspond to a particular set of dimensions. The subvectors 504 may be vector quantized, and centroid vectors for the subvectors may be assigned subvector centroid IDs 506. The subvector centroid IDs 506 may be combined into a product quantized vector 508 which may represent an approximation of the vector 502. For a vector-labeled database which retrieves data using an approximate nearest neighbor search, the decrease in accuracy based on using the product quantized vector 508 may be acceptable given the improvement in storage space.

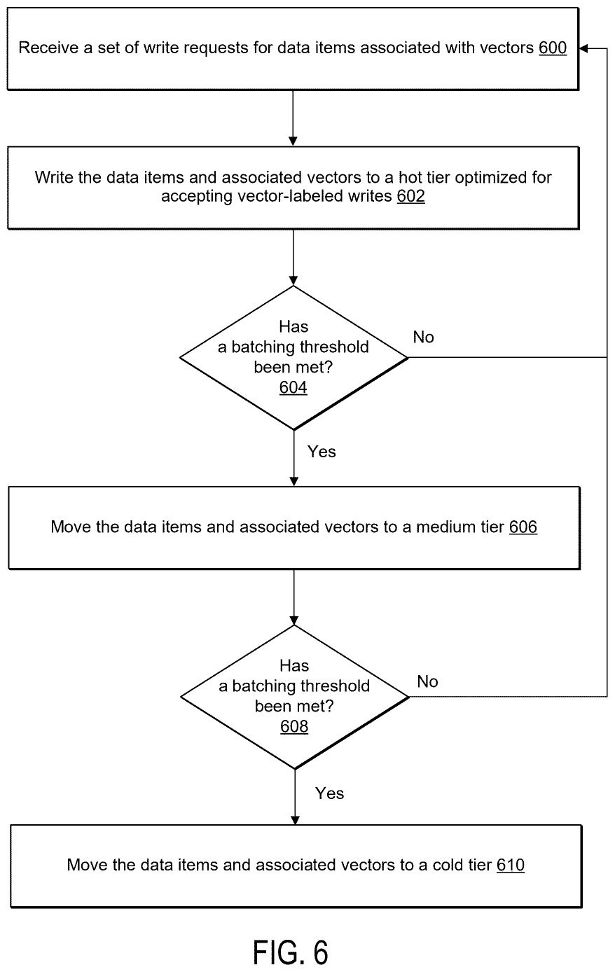

FIG. 6 is a flowchart of a process for writing new data items and associated new vectors into a vector-labeled database which includes a hot tier, a medium tier, and a cold tier, according to some embodiments.

At 600, a vector-labeled database receives a set of write request for data items associated with vectors. In some embodiments, the vector-labeled database may generate the vectors based on the data items. At 602, the vector-labeled database writes the data items and associated vectors to a hot tier optimized for accepting vector-labeled writes. At 604, the vector-labeled database determines whether a batching threshold for the hot tier has been met. A batching threshold may be time based, such as a threshold based on the amount of time since a previous batch or a threshold amount of data items which have not been updated for a threshold period of time. A batching threshold may be transaction based, such as a threshold number of transactions since a previous batch. In some embodiments, a vector-labeled database may use multiple batching thresholds.

If the vector-labeled database determines a batching threshold has not been met, the vector-labeled database returns to 600 and waits to receive an additional set of write requests for data items associated with vectors. If the vector-labeled database determines a batching threshold has been met, at 606 the vector-labeled database moves the data items and associated vectors to a medium tier. The vector-labeled database may move the most recent version of a data item and the data item's associated vector to the medium tier and delete less recent versions of the data item and the data item's associated vector from the hot tier. At 608, the vector-labeled database determines if a batching threshold for the medium tier is met. A batching threshold for the medium tier may be similar to a batching threshold for the hot tier. For embodiments which do not include a medium tier, steps 606 and 608 may be omitted. For embodiments which include multiple medium tiers, steps 606 and 608 may be repeated. Data items and vectors may generally be batched from a tier which is relatively more write-optimized to a tier which is relatively more read-optimized.

If the vector-labeled database determines a batching threshold has not been met, the vector-labeled database returns to 600 and waits to receive an additional set of write requests for data items associated with vectors. If the vector-labeled database determines a batching threshold has been met, at 610 the vector-labeled database moves the data items and associated vectors to a cold tier. The vector-labeled database may move the most recent version of a data item and the data item's associated vector to the cold tier and delete less recent versions of the data item and the data item's associated vector from the medium or hot tier.

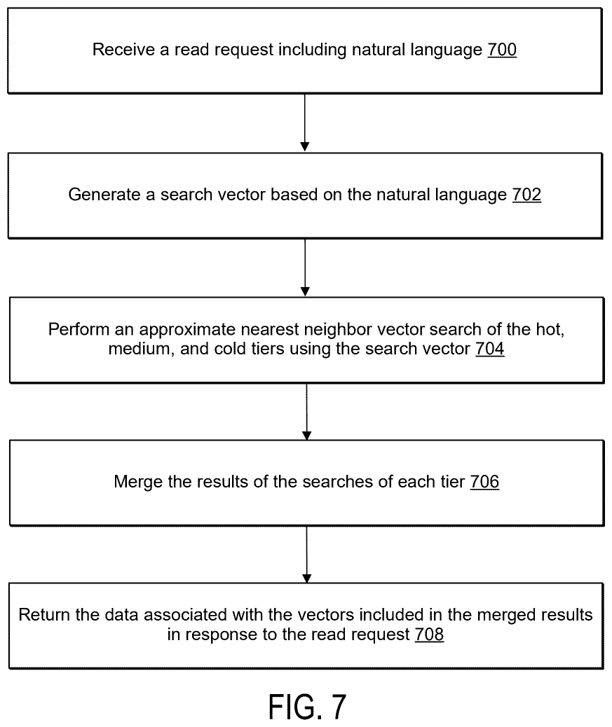

FIG. 7 is a flowchart of a process for reading data items from a vector-labeled database which includes a hot tier, a medium tier, and a cold tier, according to some embodiments.

At 700, a vector-labeled database receives a read request including natural language. At 702, the vector-labeled database generates a search vector based on the natural language. At 704, the vector-labeled database performs an approximate nearest neighbor search of the hot, medium, and cold tiers using the search vector. At 706, the vector-labeled database merges the results of the searches of the tiers into a set of vectors. At 708, the vector-labeled database returns the data associated with the vectors included in the merged results in response to the read request.

FIG. 8A is a flowchart of a process for merging search results comprising multiple versions of a data item, according to some embodiments.

To merge the results of the searches of the tiers, the vector-labeled database may use a search result merger. At 800, the search result merger determines a data item is associated with at least two of a given result of a search of the cold tier, a given result of a search of the medium tier, and a given result of a search of the hot tier. At 802, the search result merger determines which version of the data item is most recent. At 804, the search result merger selects the most recent version of the data item as a merger result.

FIG. 8B is a flowchart of a process for merging search results based on the distances between the search vector and the vectors selected in an approximate nearest neighbor search of the tiers, according to some embodiments.

To merge the results of the searches of the tiers, the vector-labeled database may use a search result merger. At 806, the search result merger determines distances between the search vector and vectors selected as search results of searches of the hot tier, medium tier, and cold tier. At 808, the search result merger ranks the vectors selected as search results based on the distances between the vectors selected as search results and the search vector. At 810, the search result merger selects data items associated with the vectors selected as search results based on the rankings.

FIG. 8C is a flowchart for a process of merging search results based on a similarity between the read request and data items associated with vectors selected in an approximate nearest neighbor search of the tiers, according to some embodiments.

To merge the results of the searches of the tiers, the vector-labeled database may use a search result merger. At 812, the search result merger identifies a segment of natural language included in a read request. At 814, the search result merger identifies one or more instances of the same segment or a related segment of natural language included in a data item associated with a vector that is an approximate nearest neighbor of the search vector. At 816, the search result merger selects the data item as a merger result.

FIG. 8D is a flowchart for a process of returning data in response to a read request which includes a return order, according to some embodiments.

To return the data associated with the vectors included in the merged results in response to the read request, at 818 the vector-labeled database receives an instruction included in the request to order the return results according to a non-vector attribute. Examples of non-vector attributes include timestamps, author, location of origin, language, and features of the data item such as a title. At 820, the vector-labeled database orders the data items selected as merger results according to the non-vector attribute. For example, the vector-labeled database may order the data items alphabetically by author. At 822, the vector-labeled database returns the data items in the order.

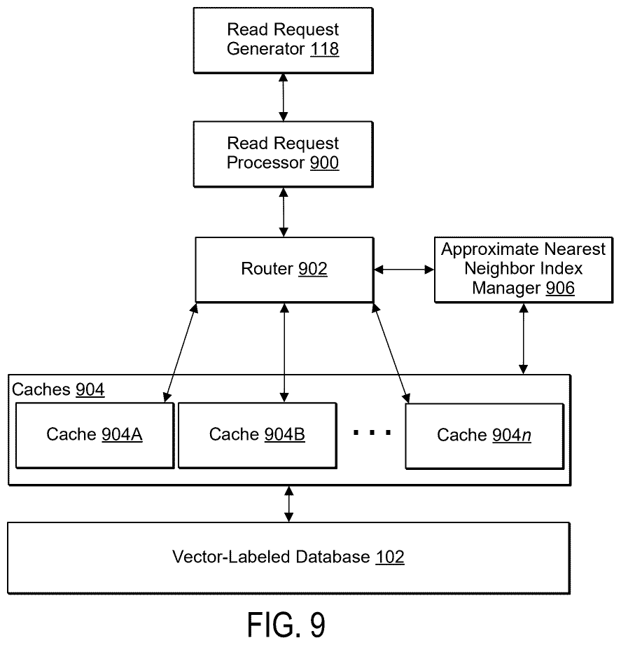

FIG. 9 is a block diagram of elements involved in a read process for a vector-labeled database which includes a cluster-aware router, according to some embodiments.

A read request processor 900 for a vector-labeled database 102 may use a set of caches 904 to store data items which have previously been selected for response to a read request, such that the data items may be read out of the cache 904 instead of out of the vector-labeled database 102 in response to a similar read request. A cluster aware router 902 may use a layer of an approximate nearest neighbor index provided by an approximate nearest neighbor index manager 906 to select a particular cache 904, i.e., one of cache 904A, cache 904B, and cache 904n. A read request processor 900 may cause data items located using an approximate nearest neighbor search of the vector-labeled database 102 to be loaded to the selected particular cache 904.

The approximate nearest neighbor index manager 906 may maintain an approximate nearest neighbor index, for example, a hierarchical navigable small world graph such as the one illustrated in FIG. 4. The approximate nearest neighbor index manager 906 may select a layer of the index to provide to the router 902. The router 902 may determine which node of the layer the search vector for a read request is closest to, and direct the read request to a cache 904 associated with the node. For example, using layer 1 400 of the example hierarchical navigable small world graph illustrated in FIG. 4, the router 902 may associate half of the caches 904 with one node and half of the caches 904 with the other. As another example, using a layer of an approximate nearest neighbor index with more nodes than available caches, the 902 may associate one or more caches with more than one node. In some embodiments, the approximate nearest neighbor index manager 906 may provide the router 902 with a layer of the index with as many nodes as there are available caches 904. The approximate nearest neighbor index manager 906 may provide layers above the selected layer, for example, if the approximate nearest neighbor index manager 906 provides the router 902 with layer 2 402 to associate with the caches 904, the approximate nearest neighbor index manager 906 may also provide layer 1 400. The router 902 may use the provided layers of the index to partially perform an approximate nearest neighbor index search.

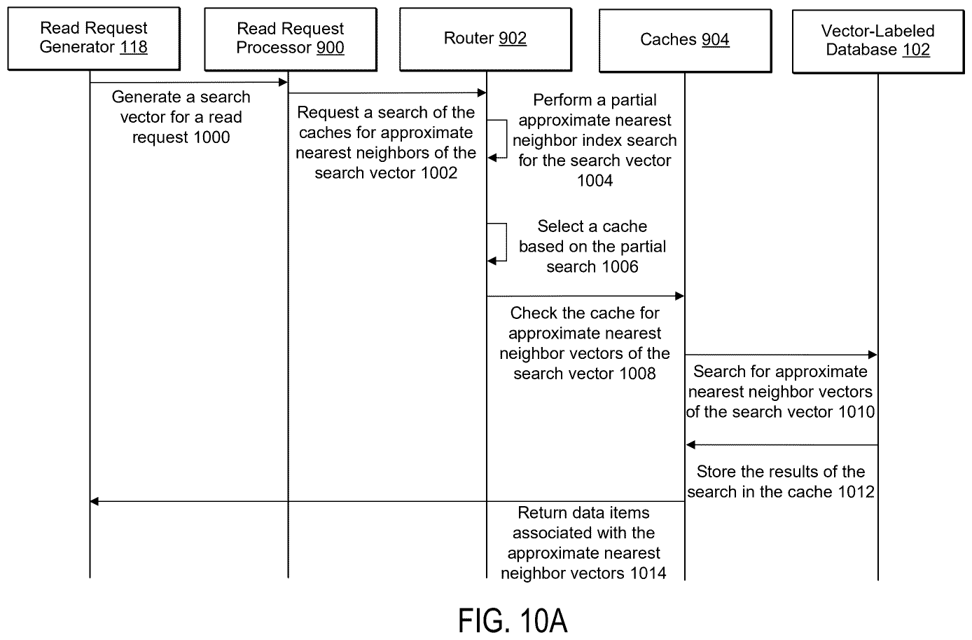

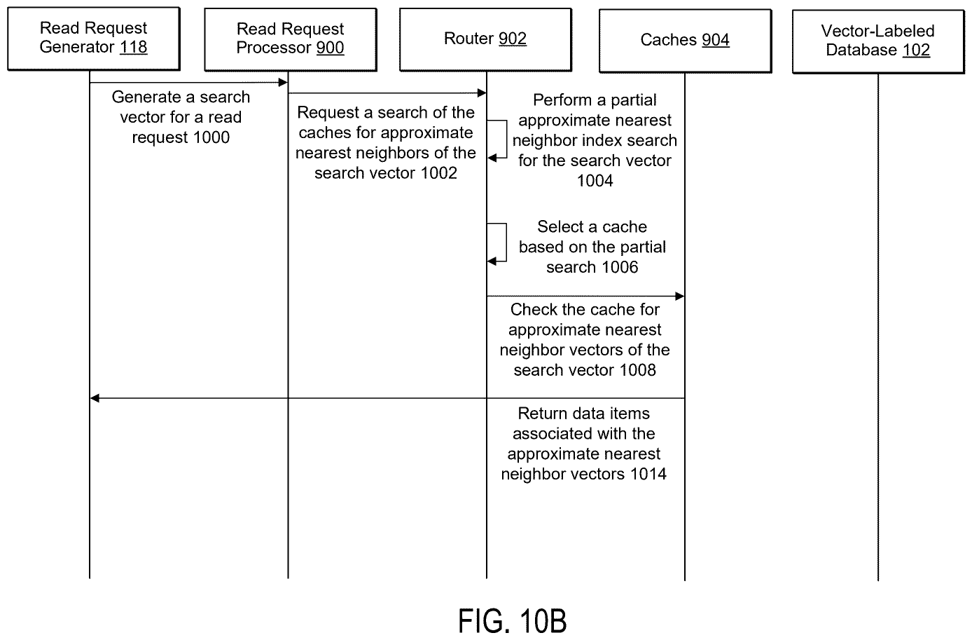

FIG. 10A is an illustration of actions taken by elements involved in a read process for a vector-labeled database when data responsive to a read is not identified in a cache, according to some embodiments.

At 1000, the read request generator 118 may generate a search vector for a read request, for example based on a data item or user input included in the read request. At 1002, the read request processor 900 may begin to direct a router 902 and caches 904 to perform a search for approximate nearest neighbors of the search vector. At 1004, the router 902 performs a partial approximate nearest neighbor index search for the search vector using one or more layers of the index provided by the approximate nearest neighbor index manager. At 1006, the router 902 selects a cache 904 based on the partial search, i.e., the router 902 selects the cache 904 that is associated with a node of the relevant index layer that is the nearest neighbor of the search vector. At 1008, the read request processor 900 causes the router 902 to check the selected cache 904 for approximate nearest neighbor vectors of the search vector.

If the router 902 finds no approximate nearest neighbor vectors of the search vector in the cache 904, at 1010, the read request processor 900 causes the cache 904 to search for approximate nearest neighbor vectors of the search vector at the vector-labeled database, for example, by completing the approximate nearest neighbor index search started by the router 902. The approximate nearest neighbor index manager 906 may provide the remainder of the index to the cache 904. The cache 904 may have access to the entire vector-labeled database, including vectors beyond a cluster of the node associated with the cache 904. The cache 904 may begin an approximate nearest neighbor search at a storage shard which is storing vectors belonging to the cluster of the node associated with the cache 904 and checks other storage shards if a nearest neighbor vector to the search vector cannot be located. The entire vector-labeled database is accessible to any given cache. The entire vector-labeled database may be sharded based on the hierarchical navigable small world graph, for example, based on the nodes of an upper layer of the hierarchical navigable small world graph, and the individual shards may be stored at different locations from each other.

At 1012, the cache 904 stores the results of the search, which may be merged results generated by a search result merger 114 as described in relation to FIG. 3. The cache 904 may store information which the vector-labeled database determines is frequently used data which is written to the cache outside of a cache miss occurrence. At 1014, the read request processor 900 causes the cache 904 to return the data items associated with the approximate nearest neighbor vectors of the search vector.

FIG. 10B is an illustration of actions taken by elements involved in a read process for a vector-labeled database when data responsive to a read is identified in a cache, according to some embodiments.

At 1000, the read request generator 118 may generate a search vector for a read request, for example based on a data item or user input included in the read request. At 1002, the read request processor 900 may begin to direct a router 902 and caches 904 to perform a search for approximate nearest neighbors of the search vector. At 1004, the router 902 performs a partial approximate nearest neighbor index search for the search vector using one or more layers of the index provided by the approximate nearest neighbor index manager. At 1006, the router 902 selects a cache 904 based on the partial search, i.e., the router 902 selects the cache 904 that is associated with a node of the relevant index layer that is the nearest neighbor of the search vector. At 1008, the read request processor 900 causes the router 902 to check the selected cache 904 for approximate nearest neighbor vectors of the search vector. If approximate nearest neighbor vectors of the search vector are found in the cache, at 1014, the read request processor 900 causes the cache 904 to return the data items associated with the approximate nearest neighbor vectors of the search vector. The read request processor 900 may quickly return the data items associated with the approximate nearest neighbor vectors of the search vector found in the cache 904 and more slowly search the vector-labeled database for additional approximate nearest neighbor vectors.

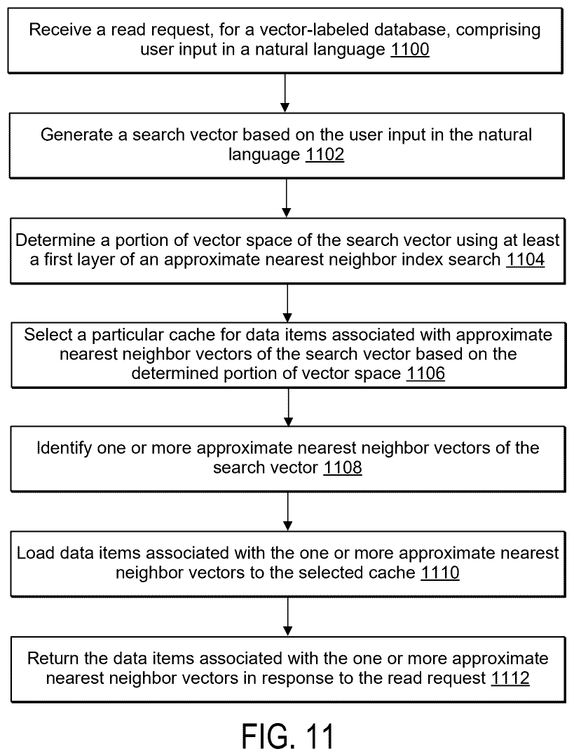

FIG. 11 is a flowchart of a process for responding to a read request for a vector-labeled database which uses a cluster-aware router, according to some embodiments.

At 1100, a read request generator receives a request to generate a read request for a vector-labeled database comprising user input in a natural language. At 1102, the read request generator generates a search vector based on the user input in the natural language. At 1104, a cluster-aware router, such as router 902 described in relation to FIG. 9, determines a portion of vector space of the search vector using at least a first layer of an approximate nearest neighbor index search, for example, an index search using layers of a hierarchical navigable small world graph as illustrated in FIG. 4. At 1106, the router selects a particular cache for data items associated with approximate nearest neighbor vectors of the search vector based on the determined portion of vector space. At 1108, the selected cache, which may be directed by a read request processor, identifies one or more approximate nearest neighbor vectors of the search vector. The read request processor may also cause the cache to perform a search result merger process, as previously described with respect to FIGS. 8A-8C. At 1110, the selected cache caches data items associated with the one or more approximate nearest neighbor vectors. At 1112, the selected cache returns the data items associated with the one or more approximate nearest neighbor vectors in response to the read request.

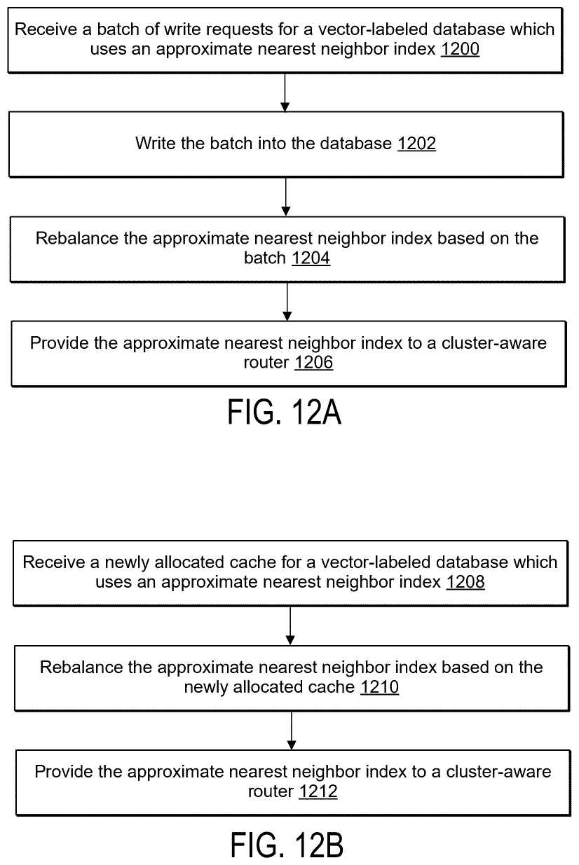

FIG. 12A is a flowchart of a process for updating an approximate nearest neighbor index search in response to a batch write, according to some embodiments.

At 1200, an index manager for a vector-labeled database, such as an approximate nearest neighbor index manager 906 as described in relation to FIG. 9, receives information about a batch of write requests for a vector-labeled database. At 1202, the vector-labeled database, or a cold tier of the vector-labeled database which is associated with an approximate nearest neighbor index, writes the batch into the vector-labeled database or a cold tier of the vector-labeled database which is associated with an approximate nearest neighbor index. At 1204, the index manager rebalances the approximate nearest neighbor index based on the new vectors included in the batch. At 1206, the index manager provides the approximate nearest neighbor index to a cluster-aware router, such as router 902 as described in relation to FIG. 9.

FIG. 12B is a flowchart of a process for updating an approximate nearest neighbor index search in response to a newly allocated cache for the vector-labeled database, according to some embodiments.

At 1208, an index manager for a vector-labeled database, such as an approximate nearest neighbor index manager 906 as described in relation to FIG. 9, receives information about a newly allocated cache for the vector-labeled database. At 1210, the index manager rebalances the approximate nearest neighbor index so that a layer of the index has a number of nodes corresponding to a number of currently available caches for the vector-labeled database. At 1212, the index manager provides the approximate nearest neighbor index to a cluster-aware router, such as router 902 as described in relation to FIG. 9.

### Example Computer System

FIG. 13 is a block diagram illustrating an example computer system that implements some or all of the techniques described herein, according to some embodiments.

FIG. 13 illustrates exemplary computer system 1300 usable to implement some or all of the embodiments as described above with reference to FIGS. 1-12B. In different embodiments, computer system 1300 may be any of various types of devices, including, but not limited to, a network computer, a mobile device, a consumer device, application server, storage device, a peripheral device such as a switch, modem, router, or in general any type of computing or electronic device.

Various embodiments of program instructions 1330, for embodiments as described herein, may be executed in one or more computer systems 1300, which may interact with various other devices. Note that any component, action, or functionality described above with respect to FIGS. 1-12B may be implemented on one or more computers configured as computer system 1300 of FIG. 13, according to various embodiments. In the illustrated embodiment, computer system 1300 includes one or more processors 1310 coupled to a system memory 1320 via an input/output (I/O) interface 1340. Computer system 1300 further includes a network interface 1350 coupled to I/O interface 1340, and one or more input/output devices 1360. In some cases, it is contemplated that embodiments may be implemented using a single instance of computer system 1300, while in other embodiments multiple such computer systems, or multiple nodes making up computer system 1300, may be configured to host different portions or instances program instructions as described above for various embodiments. For example, in one embodiment some elements of the program instructions may be implemented via one or more nodes of computer system 1300 that are distinct from those nodes implementing other elements.

In some embodiments, computer system 1300 may be implemented as a system on a chip (SoC). For example, in some embodiments, processors 1310, memory 1320, I/O interface 1340 (e.g., a fabric), etc. may be implemented in a single SoC comprising multiple components integrated into a single chip. For example, a SoC may include multiple CPU cores, a multi-core GPU, a multi-core neural engine, cache, one or more memories, etc. integrated into a single chip. In some embodiments, an SoC embodiment may implement a reduced instruction set computing (RISC) architecture, or any other suitable architecture.

System memory 1320 may be configured to store compression or decompression program instructions 1330 accessible by one or more of the processors 1310. In various embodiments, system memory 1320 may be implemented using any suitable memory technology, such as static random-access memory (SRAM), synchronous dynamic RAM (SDRAM), nonvolatile/Flash-type memory, or any other type of memory. In the illustrated embodiment, program instructions 1330 may be configured to implement any of the functionality described above. In some embodiments, program instructions and/or data may be received, sent, or stored upon different types of computer-accessible media or on similar media separate from system memory 1320 or computer system 1300.

In one embodiment, I/O interface 1340 may be configured to coordinate I/O traffic between processor 1310, system memory 1320, and any peripheral devices in the device, including network interface 1350 or other peripheral interfaces, such as input/output devices 1360. In some embodiments, I/O interface 1340 may perform any necessary protocol, timing, or other data transformations to convert data signals from one component (e.g., system memory 1320) into a format suitable for use by another component (e.g., processor 1310). In some embodiments, I/O interface 1340 may include support for devices attached through various types of peripheral buses, such as a variant of the Peripheral Component Interconnect (PCI) bus standard or the Universal Serial Bus (USB) standard, for example. In some embodiments, the function of I/O interface 1340 may be split into two or more separate components, such as a north bridge and a south bridge, for example. Also, in some embodiments, some or all of the functionality of I/O interface 1340, such as an interface to system memory 1320, may be incorporated directly into processor 1310.

Network interface 1350 may be configured to allow data to be exchanged between computer system 1300 and other devices attached to a network 1370 (e.g., carrier or agent devices) or between nodes of computer system 1300. Network 1370 may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 1350 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 1360 may, in some embodiments, include one or more display terminals, keyboards, keypads, touchpads, scanning devices, voice or optical recognition devices, or any other devices suitable for entering or accessing data by one or more computer systems 1300. Multiple input/output devices 1360 may be present in computer system 1300 or may be distributed on various nodes of computer system 1300. In some embodiments, similar input/output devices may be separate from computer system 1300 and may interact with one or more nodes of computer system 1300 through a wired or wireless connection, such as over network interface 1350.

As shown in FIG. 13, memory 1320 may include program instructions 1330, which may be processor-executable to implement any element or action described above. In one embodiment, the program instructions may implement the methods described above. In other embodiments, different elements and data may be included.

Computer system 1300 may also be connected to other devices that are not illustrated, or instead may operate as a stand-alone system. In addition, the functionality provided by the illustrated components may in some embodiments, be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1300 may be transmitted to computer system 1300 via transmission media or signals such as electrical, electromagnetic, or digital signals, conveyed via a communication medium such as a network and/or a wireless link. Various embodiments may further include receiving, sending, or storing instructions and/or data implemented in accordance with the foregoing description upon a computer-accessible medium. Generally speaking, a computer-accessible medium may include a non-transitory, computer-readable storage medium or memory medium such as magnetic or optical media, e.g., disk or DVD/CD-ROM, volatile or non-volatile media such as RAM (e.g., SDRAM, DDR, RDRAM, SRAM, etc.), ROM, etc. In some embodiments, a computer-accessible medium may include transmission media or signals such as electrical, electromagnetic, or digital signals, conveyed via a communication medium such as network and/or a wireless link.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

1. A system, comprising:
a router; and
one or more computing resources configured to implement a set of caches and a vector-labeled database, wherein results of a prior read request are added to a given cache in response to the prior read request;
wherein the router is configured to:
receive a read request for one or more data items associated with one or more approximate nearest neighbor vectors of a request vector, wherein the one or more approximate nearest neighbor vectors are maintained in the vector-labeled database;
determine a portion of vector space for the request vector using at least a first layer of an approximate nearest neighbor index search;
select, based on the determined portion of vector space for the request vector, a particular cache of the set of caches;
cause the particular cache to be checked for the one or more approximate nearest neighbor vectors of the request vector; and
cause the one or more data items associated with the one or more approximate nearest neighbor vectors to be returned in response to the request.

2. The system of claim 1, wherein:
any given portion of the vector-labeled database is accessible by any given cache of the set of caches; and
the router updates the first layer of the approximate nearest neighbor index search when a number of caches in the set of caches changes.

3. The system of claim 1, wherein the vector-labeled database is sharded based at least in part on the first layer of the approximate nearest neighbor index search.

4. The system of claim 1, wherein the vector-labeled database stores vectors that are compressed using vector quantization or product quantization.

5. The system of claim 1, wherein the approximate nearest neighbor index search uses a hierarchical navigable small world graph.

6. The system of claim 1, wherein the vector-labeled database is a cold tier for a multi-tier vector-labeled database architecture.

7. A method, comprising:
receiving a read request for one or more data items associated with one or more approximate nearest neighbor vectors of a request vector;
determining a portion of vector space for the request vector using at least a first layer of an approximate nearest neighbor index search;
selecting, based on the determined portion of vector space for the request vector, a cache from a set of caches, wherein results of a prior read request are added to a given cache in response to the prior read request; and,
causing the particular cache to be checked for the one or more approximate nearest neighbor vectors of the request vector.

8. The method of claim 7, further comprising:
generating the request vector based on user input; and
returning the one or more data items associated with the one or more approximate nearest neighbor vectors in response to the read request.

9. The method of claim 8, further comprising:
determining to return particular ones of the one or more data items associated with the one or more approximate nearest neighbor vectors based on a relationship between the user input and the particular ones of the one or more data items associated with the one or more approximate nearest neighbor vectors.

10. The method of claim 8, wherein the user input is natural language.

11. The method of claim 7, wherein a database labeled according to the vector space is sharded based on the first layer of the approximate nearest neighbor index search.

12. The method of claim 7, wherein a database labeled according to the vector space stores vectors that are compressed using vector quantization or product quantization.

13. The method of claim 7, wherein the approximate nearest neighbor index search uses a hierarchical navigable small world graph.

14. A non-transitory computer-readable storage media storing program instructions, wherein the program instructions, when executed on or across one or more processors, cause the one or more processors to:
receive a read request for one or more data items associated with one or more approximate nearest neighbor vectors of a request vector;
determine a portion of vector space for the request vector using at least a first layer of an approximate nearest neighbor index search; and
select, based on the determined portion of vector space for the request vector, a cache from a set of caches, wherein results of a prior read request are added to a given cache in response to the prior read request; and
cause the particular cache to be checked for the one or more approximate nearest neighbor vectors of the request vector.

15. The computer-readable storage media of claim 14, wherein the program instructions, when executed on or across one or more processors, further cause the one or more processors to:
generate the request vector based on user input; and
return one or more of the one or more data items associated with the one or more approximate nearest neighbor vectors in response to the read request.

16. The computer-readable storage media of claim 15, wherein the program instructions, when executed on or across one or more processors, further cause the one or more processors to:
determining to return a particular one of the one or more data items associated with the one or more approximate nearest neighbor vectors based on a relationship of the user input to the particular one of the one or more data items associated with the one or more approximate nearest neighbor vectors.

17. The computer-readable storage media of claim 15, wherein the user input is natural language.

18. The computer-readable storage media of claim 14, wherein a database labeled according to the vector space is sharded based on the first layer of the approximate nearest neighbor index search.

19. The computer-readable storage media of claim 14, wherein a database labeled according to the vector space stores vectors that are compressed using vector quantization or product quantization.

20. The computer-readable storage media of claim 14, wherein the approximate nearest neighbor index search uses a hierarchical navigable small world graph.
